(19) United States
(12) Patent Application Publication
(10) Pub. No.: US 2026/0316321 A1
(43) Pub. Date: Oct. 15, 2026

(54) ELECTRIC PLANER DEVICE, BEVEL SOLE AND METHOD

(71) Applicant: Festool GmbH, Wendlingen (DE)

(72) Inventors: Marco Christoph BROSCH, Wolfschlugen (DE); Jiri NOVOTNY, Cvikov (CZ); Petr NOVÁCEK, Nový Bor (CZ)

(21) Appl. No.: 19/633,469

(22) Filed: Mar. 30, 2026

(30) Foreign Application Priority Data
Mar. 31, 2025 (EP) 25167545

(51) Int. Cl. B27C 1/08; B27C 1/14

(52) U.S. Cl. CPC B27C 1/08; B27C 1/14

(57) ABSTRACT

An electric planer device that includes a chamfer sole, electric planer apparatus, which has a planer shaft, an electric drive unit, and a planer sole. The electric planer device can be selectively set into a planar planing configuration or into a chamfer planing configuration. The electric planer device in the planar planing configuration can be placed flatly with a planer sole contact surface of the planer sole onto a planar workpiece surface in order to perform, during a feed of the electric planer device, a planar chip removal from the workpiece surface with the planer shaft. The electric planer device in the chamfer planing configuration can be placed flatly with two chamfer sole contact surfaces simultaneously onto two workpiece surfaces converging to a workpiece edge in order to chamfer, during a feed of the electric planer device, the workpiece edge with the planer shaft.

### CROSS REFERENCE TO RELATED APLICATIONS

This application claims priority to European Patent Application No. 25167545.0 filed on Mar. 31, 2025, which is incorporated reference.

### BACKGROUND

The invention relates to an electric planer device, comprising an electric planer apparatus, which has a planer shaft, an electric drive unit for driving the planer shaft, and a planer sole.

There are conventional electric planer apparatuses that have a V-groove in their planer sole, with which they can be guided along a workpiece edge to facilitate chamfering of the workpiece edge. Furthermore, there are conventional chamfer planers whose (permanently installed) planer sole is designed as a chamfer sole.

### SUMMARY

An object of the invention is to provide a flexibly usable electric planer device.

The object is achieved by an electric planer device according to claim 1. The electric planer device comprises a chamfer sole and can be selectively set into a planar planing configuration or into a chamfer planing configuration, wherein the electric planer device in the planar planing configuration can be placed flatly with a planer sole contact surface of the planer sole onto a planar workpiece surface in order to perform a planar chip removal from the workpiece surface with the planer shaft during a feed of the electric planer device relative to the planar workpiece surface, and wherein the electric planer device in the chamfer planing configuration can be placed flatly with two chamfer sole contact surfaces of the chamfer sole simultaneously onto two workpiece surfaces converging to form a workpiece edge in order to chamfer the workpiece edge with the planer shaft during a feed of the electric planer device relative to the workpiece edge.

The chamfer sole contact surfaces each preferably extend over at least 1/4 or 1/3 of the width of the chamfer sole (and/or the width of the planer sole). In this way, a large contact support can be provided in the chamfer planing configuration, which can prevent slipping and/or tilting of the electric planer device relative to the workpiece.

Advantageous further developments are the subject of the dependent claims.

The invention further relates to a chamfer sole having an attachment interface for removable attachment to an in particular hand-guided electric planer apparatus, in order to form with the electric planer apparatus an electric planer device usable as a chamfer planer, wherein the chamfer sole comprises a chamfer sole body with two chamfer sole contact surfaces, which define two intersecting contact planes and serve for the simultaneous flat contact of the chamfer sole on two workpiece surfaces converging to a workpiece edge, as well as preferably a chamfer sole clearance arranged between the two chamfer sole contact surfaces, through which the workpiece edge can be guided to a planer shaft of the electric planer apparatus in order to chamfer the workpiece edge with the planer shaft.

The invention further relates to a method for operating the electric planer device, comprising the steps:
in the planar planing configuration, flatly placing the planer sole contact surface onto the planar workpiece surface and feeding the electric planer device relative to the planar workpiece surface to perform the planar chip removal with the planer shaft, setting the electric planer device into the chamfer planing configuration,
in the chamfer planing configuration, simultaneously placing the chamfer sole contact surfaces flatly onto the workpiece surfaces converging to the workpiece edge and feeding the electric planer device relative to the workpiece edge to chamfer the workpiece edge.

### BRIEF DESCRIPTION OF THE DRAWINGS

Further exemplary details as well as exemplary embodiments are explained below with reference to the figures. Thereby shows:

FIG. 1 an electric planer device in a planar planing configuration and a workpiece,

FIG. 2 an electric planer device in a chamfer planing configuration and a workpiece,

FIG. 3 an electric planer apparatus in a bottom view,

FIG. 4 a chamfer sole according to a first variant,

FIG. 5 the chamfer sole according to the first variant in a side view,

FIG. 6 the chamfer sole according to the first variant in a front view,

FIG. 7 the chamfer sole according to the first variant in a top view,

FIG. 8 the chamfer sole according to the first variant in a bottom view,

FIG. 9 a chamfer sole according to a second variant,

FIG. 10 a chamfer sole according to a third variant,

FIG. 11 a chamfer sole according to a fourth variant in an exploded view, and

FIG. 12 a side view of the electric planer device in the chamfer planing configuration, wherein the chamfer sole is configured according to the first variant.

### DETAILED DESCRIPTION

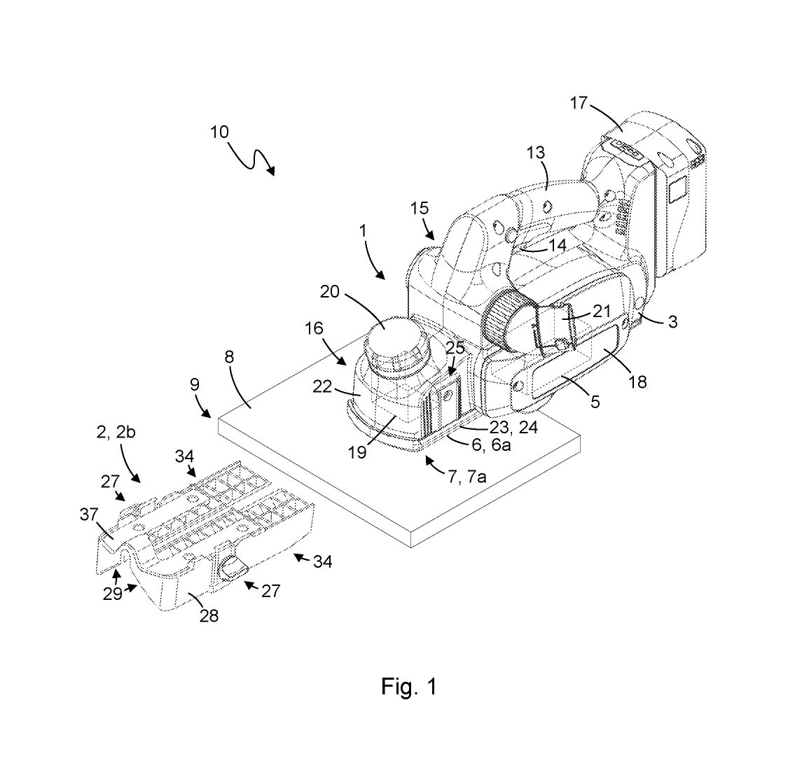

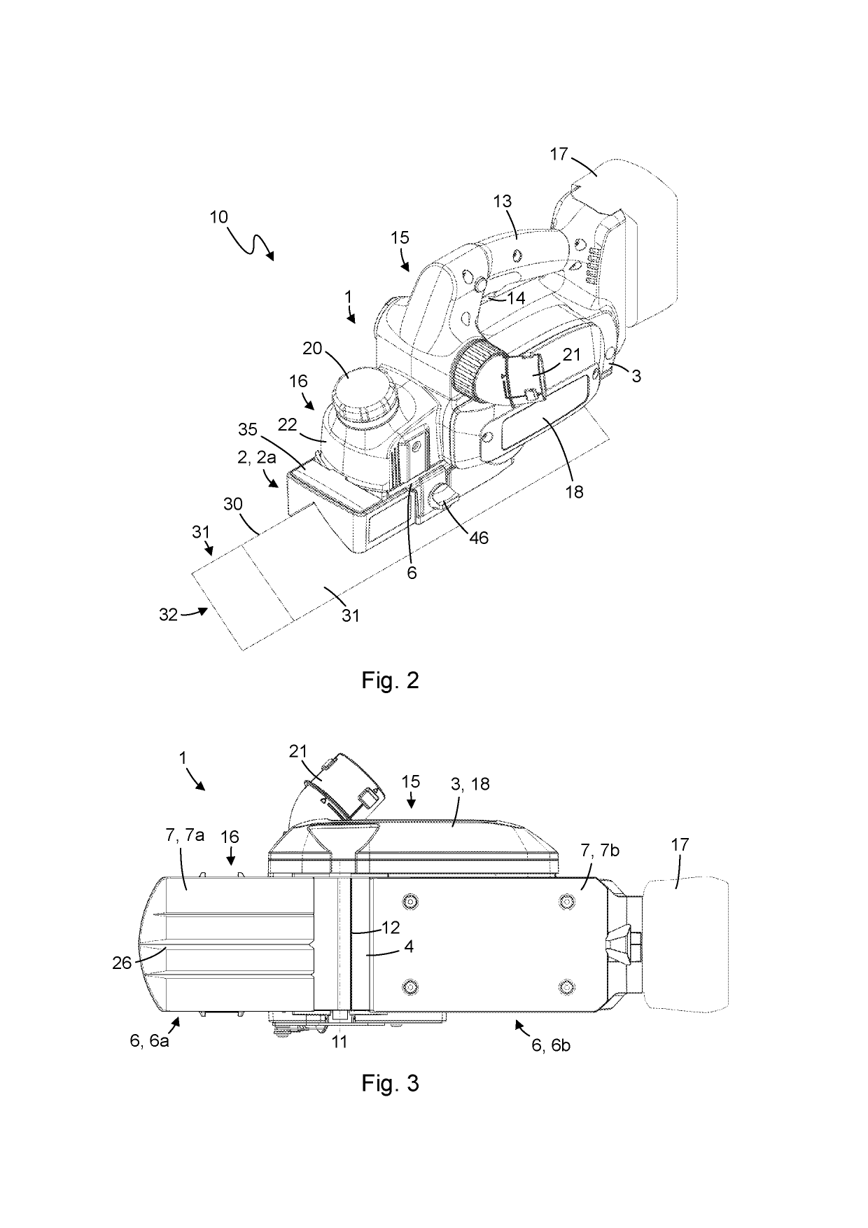

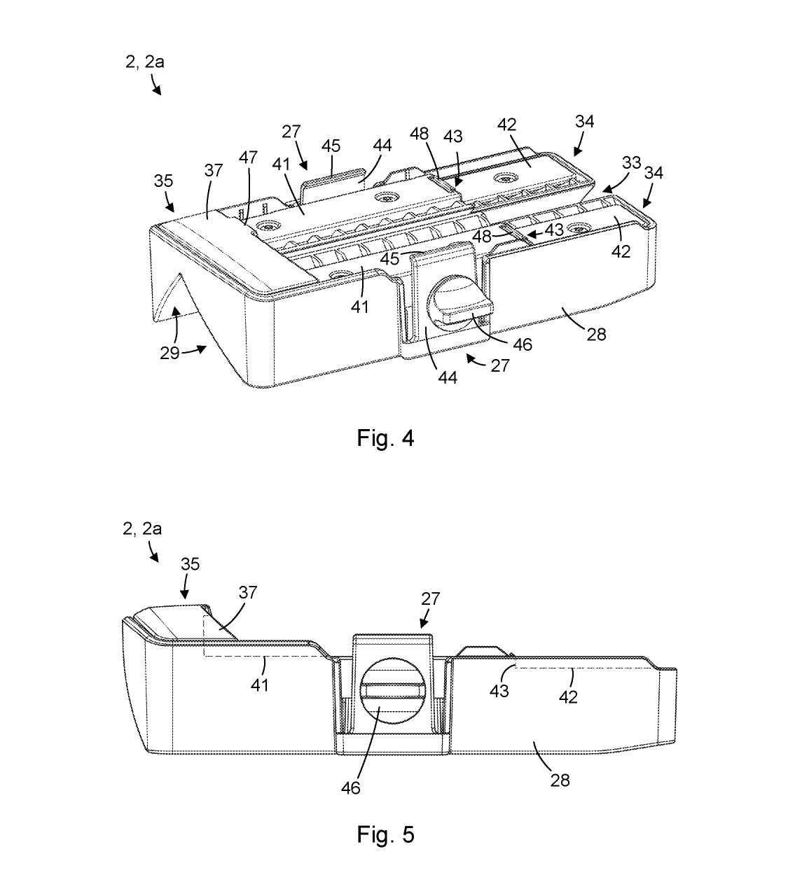

FIG. 1 shows an electric planer device 10, which exemplarily comprises an electric planer apparatus 1 and a chamfer sole 2. In FIG. 1, the electric planer device 10 is shown in a planar planing configuration, in which the chamfer sole 2 is in particular completely removed from the electric planer apparatus 1. In FIG. 2, the electric planer device 10 is shown in a chamfer planing configuration, in which the chamfer sole 2 is attached to the electric planer apparatus 1. It should be pointed out that two different variants of the chamfer sole 2 are shown in FIGS. 1 and 2; effectively, however, one and the same chamfer sole 2 would be present in both configurations, which can be configured according to any variant, in particular according to one of the variants discussed in more detail below.

The electric planer apparatus 1 is exemplarily designed as a hand-guided electric planer apparatus. It should be pointed out that the electric planer apparatus 1 and the chamfer sole 2 can also each be provided individually.

The following explanations relate in particular to an orientation of the electric planer device 10 – i.e., of the electric planer apparatus 1 and the chamfer sole 2 – in which a planer sole contact surface 7 of the electric planer apparatus 1 is oriented horizontally and with its normal vector pointing vertically downwards; the explanations thus relate in particular to the orientation of the electric planer device 10 shown in FIG. 1.

The electric planer apparatus 1 preferably has an elongated basic shape and extends along an (imaginary) longitudinal axis. The direction of the longitudinal axis is in particular equal to the feed direction of the electric planer apparatus 1. The electric planer apparatus 1 expediently comprises an outer housing 3. The electric planer apparatus 1 preferably has a handle 13, which is expediently arranged on the outer housing 3 or is part of the outer housing 3. The handle 13 can be gripped, in particular completely gripped, with one hand in order to carry and/or guide the electric planer apparatus 1 or the electric planer device 10, in particular with one hand. The handle 13 is expediently located on the upper side of the electric planer apparatus 1. The electric planer apparatus 1 has an operating element 14, exemplarily designed as a trigger button, with which a drive of a planer shaft 4 of the electric planer apparatus 1 can be controlled, in particular started and/or stopped. The operating element 14 is exemplarily arranged on the handle 13. 0

The electric planer apparatus 1 comprises the planer shaft 4, which is shown exemplarily in FIG. 3 and is expediently arranged on the underside of the electric planer apparatus 1, in particular of the outer housing. The planer shaft 4 can be set into a rotational movement around a planer shaft rotation axis 11. The planer shaft 4 comprises a cutting edge 12, which exemplarily runs in the axial direction of the planer shaft rotation axis 11. The planer shaft rotation axis 11 is oriented perpendicular to the feed direction of the electric planer apparatus 1. The axial direction of the planer shaft rotation axis 11 and/or a horizontal direction orthogonal to the longitudinal axis shall also be referred to as the transverse direction.

The electric planer apparatus 1 comprises an electric drive unit 5 for driving the planer shaft 4 in order to expediently set it into the rotational movement. The electric drive unit 5 is arranged in the outer housing 3 and is shown schematically as a cuboid with dashed lines in FIG. 1. The electric drive unit 5 comprises an electric motor and optionally a gear.

The electric planer apparatus 1 comprises a planer sole 6, which is arranged in particular on the underside of the outer housing 3 and/or forms at least a part of the underside of the outer housing 3. The planer sole 6 comprises a planer sole contact surface 7, with which the electric planer apparatus 1 can be placed onto a workpiece 9 in order to plane the workpiece 9 with the planer shaft 4. The planer sole contact surface 7 is arranged on the underside of the planer sole 6. Expediently, the planer sole contact surface 7 is oriented parallel to the planer shaft rotation axis 11. The planer sole 6 extends in a longitudinal direction, which corresponds in particular to the feed direction of the electric planer apparatus 1.

Expediently, the planer sole 6 is divided into two parts – a front planer sole part, which shall also be referred to as support table 6a, and a rear planer sole part 6b. The part of the planer sole contact surface 7 belonging to the support table 6a shall be referred to as the front planer sole contact surface 7a and the part of the planer sole contact surface 7 belonging to the rear planer sole part 6b as the rear planer sole contact surface 7b. The normal vectors of the planer sole contact surfaces 7a, 7b point in the same direction – in particular vertically downwards. The planer sole contact surfaces 7a, 7b are in particular each designed to be flat. A flat contact surface shall in particular denote a surface that defines a contact plane. The planer sole contact surfaces 7a, 7b can each have one or multiple depressions, for example grooves. In particular, the support table 6a or the front planer sole contact surface 7a can have a V-groove 26 extending along the feed direction, which in particular extends over the entire length of the support table 6a or the front planer sole contact surface 7a and is advantageously arranged centrally in the transverse direction in the front planer sole contact surface 7a. Optionally, the support table 6a or the front planer sole contact surface 7a can have multiple V-grooves arranged in particular parallel to one another.

The rear planer sole part 6b adjoins the support table 6a in the longitudinal direction of the planer sole 6. The planer shaft 4 is expediently arranged between the support table 6a and the rear planer sole part 6b.

The support table 6a is expediently adjustable relative to the planer shaft 4 (and in particular to the rear planer sole part 6b), in particular in its height, thus in particular along an adjustment axis that is aligned vertically or perpendicularly to the planer sole contact surface 7. The support table 6a is adjustable relative to the planer shaft 4 in order to set a depth of a planar chip removal in the planar planing configuration and/or to set a chamfer width of the chamfer to be produced in the chamfer planing configuration.

Preferably, the electric planer apparatus 1 has an adjustment mechanism 19, for example a screw mechanism, with which the support table 6a can be adjusted in its height. Expediently, the electric planer apparatus 1 has an adjustment operating element 20 via whose actuation the support table 6a can be adjusted in its height. The adjustment operating element 20 is exemplarily designed as a rotary element, in particular as a rotary dial, and is in particular coupled with the adjustment mechanism 19 or is part of the adjustment mechanism 19.

The electric planer apparatus 1 has an apparatus main section 15, which is expediently arranged centrally along a (horizontally aligned) longitudinal axis of the electric planer apparatus 1. Exemplarily, the apparatus main section 15 comprises that part of the outer housing 3 in which the electric drive unit 5 is arranged, and/or comprises the handle 13, the planer shaft 4, and/or the rear planer sole part 6b. The electric planer apparatus 1 expediently has a motor housing section 18, in which the electric drive unit 5, in particular the electric motor, is arranged. The motor housing section 18 is exemplarily part of the outer housing 3 and/or of the apparatus main section 15. Exemplarily, the motor housing section 18 protrudes in the width direction beyond the planer sole 6. The width direction is aligned horizontally and runs perpendicular to the feed direction and/or longitudinal axis of the electric planer apparatus 1. The electric planer apparatus 1 expediently has a hose port 21, to which an extraction hose for extracting chips generated during planing can be attached. The hose port 21 is exemplarily arranged laterally on the apparatus main section 15, in particular above the motor housing section 18.

The electric planer apparatus 1 further has an apparatus front section 16, which adjoins the apparatus main section 15 forwardly along the longitudinal axis. The apparatus front section 16 expediently comprises a housing front section 22 of the outer housing 3, the support table 6a, the adjustment mechanism 19, and/or the adjustment operating element 20. The adjustment operating element 20 is arranged externally on the outer housing 3, in particular the housing front section 22, in particular on the upper side. The adjustment mechanism 19 is arranged in the outer housing 3, in particular the housing front section 22. The support table 6a is exemplarily arranged on the lower side of the housing front section 22.

The electric planer apparatus 1 has an attachment structure 23 to which the chamfer sole 2 can be attached in order to provide the chamfer planing configuration. The attachment structure 23 exemplarily comprises one or multiple attachment sections 24, which are arranged in particular on the longitudinal side of the electric planer apparatus 1 and/or form a part of the support table 6a. Exemplarily, the support table 6a comprises on at least two opposite sides, preferably on three sides, more preferably on four sides, a respective attachment section 24, which extends perpendicular to the front planer sole contact surface 7a and preferably has an undercut with respect to a vertical to the front planer sole contact surface 7a. Exemplarily, the support table 6a comprises on each of its two lateral sides – i.e., the sides located on the longitudinal sides of the electric planer apparatus 1 – a respective attachment section 24, which protrudes laterally outwards – i.e., outwards in the width direction – in particular with respect to the housing front section 22. Each attachment section 24 expediently extends over more than half or over the entire extension of the sides of the support table 6a running in the direction of the longitudinal axis of the electric planer apparatus 1. The attachment sections 24 can be configured, for example, as attachment protrusions and/or outer edge regions of the support table 6a.

The electric planer apparatus 1, in particular the apparatus front section 16, optionally has a rebate fence attachment interface 25 for attaching one or two rebate fences. The rebate fence attachment interface 25 exemplarily comprises one or two screw receptacles. Exemplarily, the attachment structure 23 is arranged below the rebate fence attachment interface 25.

The electric planer apparatus 1 further has an in particular removable battery pack 17, which is exemplarily attached to the apparatus main section 15 and serves to supply energy to the electric drive unit 5. Exemplarily, the battery pack 17 is arranged rearwardly along the longitudinal axis on the apparatus main section 15. Alternatively or additionally to the battery pack, the electric planer apparatus 1 can have a mains connection, in particular a mains plug.

The chamfer sole 2 will be discussed in more detail below. First, features of the chamfer sole 2 will be explained which can be present in multiple, in particular all, variants of the chamfer sole 2.

The chamfer sole 2 is exemplarily designed as a single part. The chamfer sole 2 consists, for example, of multiple structurally interconnected components or is designed in one piece. The chamfer sole 2 is in particular not an arrangement of separate, i.e., non-interconnected, components. The chamfer sole 2 is therefore handleable in particular as a single part.

The chamfer sole 2 has an elongated basic shape and extends along an (imaginary) longitudinal axis.

The chamfer sole 2 has an attachment interface 27 for removably attaching the chamfer sole 2 to the electric planer apparatus 1, in order to form with the electric planer apparatus 1 the electric planer device 10 (in the chamfer planing configuration) usable as a chamfer planer.

The chamfer sole 2 comprises a chamfer sole body 28 with two chamfer sole contact surfaces 29, which define two intersecting contact planes. The expression that the chamfer sole contact surfaces 29 define two intersecting contact planes means in particular that the chamfer sole contact surfaces 29, in particular the contact planes, are aligned at an angle of less than 180 degrees to one another. In particular, the two chamfer sole contact surfaces 29 face each other in the width direction; the two chamfer sole contact surfaces 29 are therefore in particular facing one another. Preferably, the angle between the chamfer sole contact surfaces 29, in particular the contact planes, is between 80 degrees and 100 degrees, and is in particular equal to 90 degrees. The chamfer sole contact surfaces 29 are each preferably designed to be flat. Exemplarily, the two chamfer sole contact surfaces 29 are designed to be equal in size.

The chamfer sole contact surfaces 29 serve for the simultaneous flat contact of the chamfer sole 2 on two workpiece surfaces 31 converging to a workpiece edge 30. The two workpiece surfaces 31 converge, for example, at an angle (in particular an interior angle) of 90 degrees.

The workpiece surfaces 31 are part of a workpiece 32, in particular a wooden workpiece. The workpiece 32 can also be referred to as the second workpiece. Exemplarily, the workpiece 32 is a squared timber. The workpiece surfaces 31 are expediently each flat.

The chamfer sole contact surfaces 29 exemplarily extend over more than half of the longitudinal extension of the chamfer sole 2, in particular over the entire longitudinal extension of the chamfer sole 2. The chamfer sole contact surfaces 29 are each angled by 45 degrees relative to a horizontal plane. In the chamfer planing configuration, the chamfer sole contact surfaces 29 are each angled by 45 degrees relative to the planer sole contact surface 7 and/or the planer shaft rotation axis 11.

Exemplarily, the chamfer sole contact surfaces 29 delimit a workpiece receiving space which in particular extends over the entire longitudinal extension of the chamfer sole 2 and/or opens towards the underside of the chamfer sole 2, i.e., becomes increasingly wider towards the underside. The workpiece receiving space exemplarily has the basic shape of a right prism with a (in particular isosceles) triangular base. The chamfer sole 2 exemplarily has the basic shape of a cuboid from which the aforementioned prism has been subtracted to form the workpiece receiving space.

The chamfer sole 2 has a chamfer sole clearance 33 arranged between the two chamfer sole contact surfaces 29, through which the workpiece edge 30 can be guided to the planer shaft 4 of the electric planer apparatus 1 in order to chamfer the workpiece edge 30 with the planer shaft 4. The chamfer sole clearance 33 is designed in particular as a gap. When the electric planer device 10 is placed with the chamfer sole contact surfaces 29 from above onto the workpiece surfaces 31, the workpiece edge 30 (to be chamfered) is moved through the chamfer sole clearance 33 onto the upper side of the chamfer sole 2 facing the planer shaft 4, so that the workpiece edge can be brought into contact with the planer shaft 4 and chamfered (in particular by a feed of the electric planer device 10). The chamfer sole clearance 33 expediently extends over the entire longitudinal extension of the chamfer sole 2.

The chamfer sole 2 has in particular a U-shaped basic shape in a top view (cf. FIG. 7). Exemplarily, the chamfer sole 2 has two chamfer sole legs 34. Each chamfer sole leg 34 provides a respective chamfer sole contact surface 29. The chamfer sole clearance 33 runs between the chamfer sole legs 34.

The chamfer sole 2 comprises a connecting section 35, which is located in particular in a front region of the chamfer sole 2. The chamfer sole legs 34 are interconnected via the connecting section 35, in particular exclusively via the connecting section 35. The connecting section 35 exemplarily runs above the chamfer sole clearance 33 and in particular constitutes a bridge (connecting the chamfer sole legs 34) over the chamfer sole clearance 33.

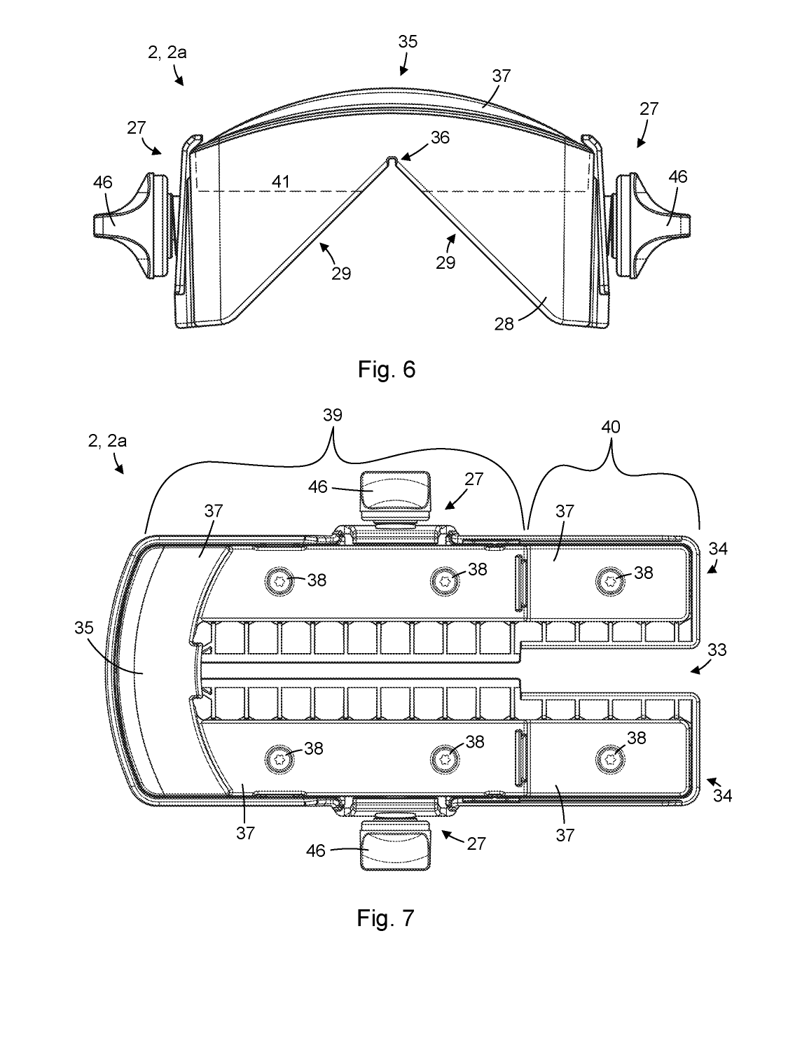

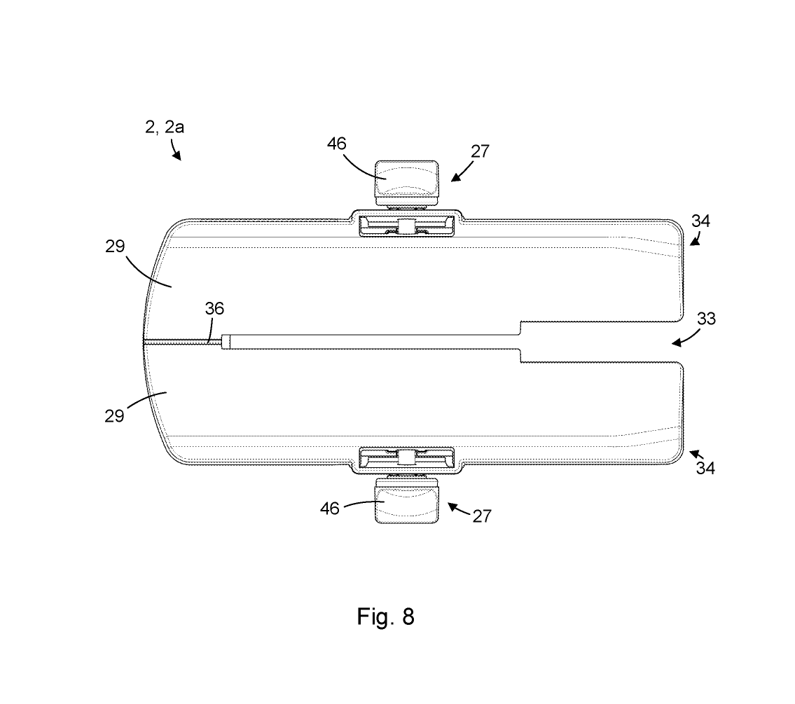

Preferably, the connecting section 35 has a cutout 36 along an imaginary intersecting line at which the contact planes defined by the chamfer sole contact surfaces 29 intersect. The cutout 36 serves in particular to ensure that when the chamfer sole contact surfaces 29 are placed flatly on the converging workpiece surfaces 31, the chamfer sole 2 does not rest on the workpiece edge 30. The cutout 36 can be seen in particular in FIGS. 6 and 8. Expediently, the cutout 36 extends upwards further than the intersecting line of the contact planes. The cutout 36 extends along the longitudinal axis over the entire connecting section 35.

As mentioned above, the chamfer sole 2 comprises the chamfer sole body 28, which provides the two chamfer sole contact surfaces 29. Preferably, the chamfer sole body 28 is manufactured from a first material, in particular plastic. Exemplarily, the chamfer sole 2 further comprises at least one stiffening element 37 attached to the chamfer sole body 28, which is manufactured from a second material (different from the first material), in particular metal.

The chamfer sole body 28 is, for example, an injection-molded part. The chamfer sole body 28 exemplarily has a rib structure, which extends in particular over the longitudinal extension of the chamfer sole body 28.

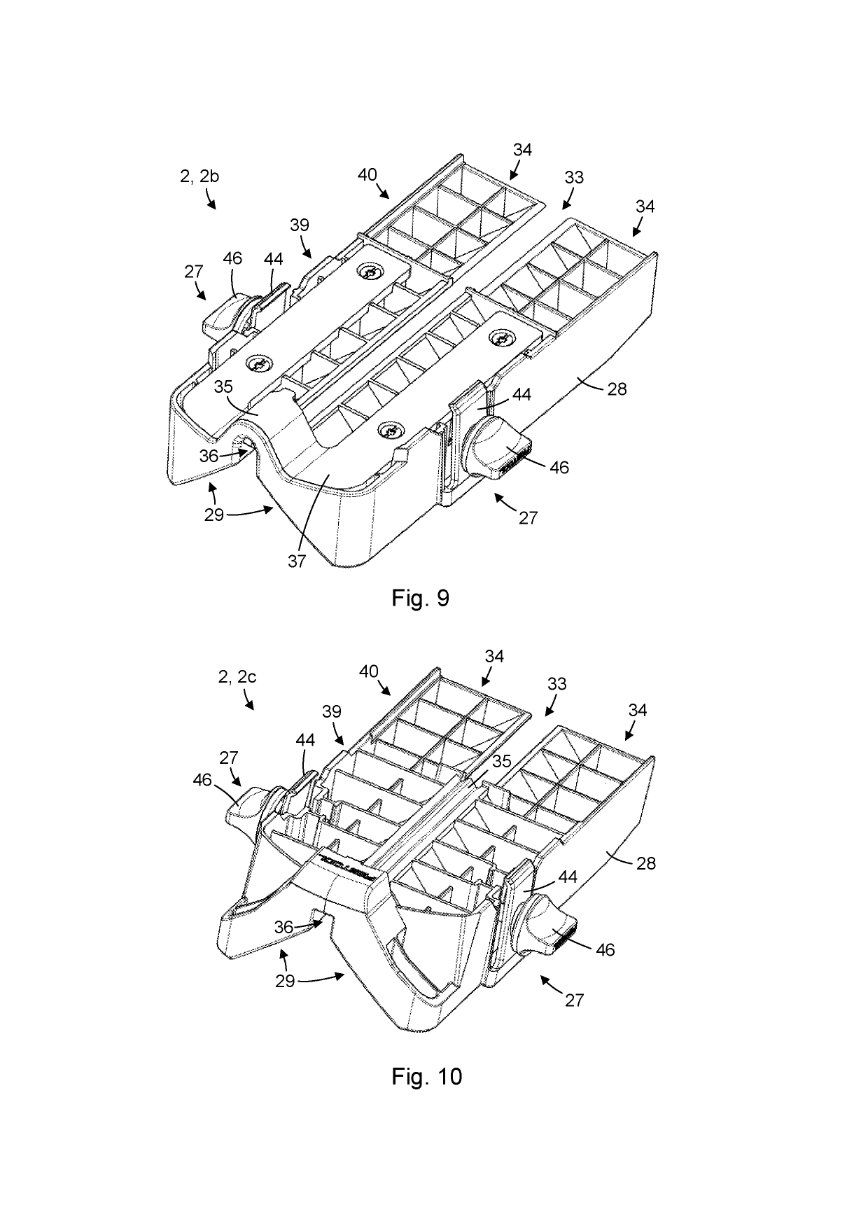

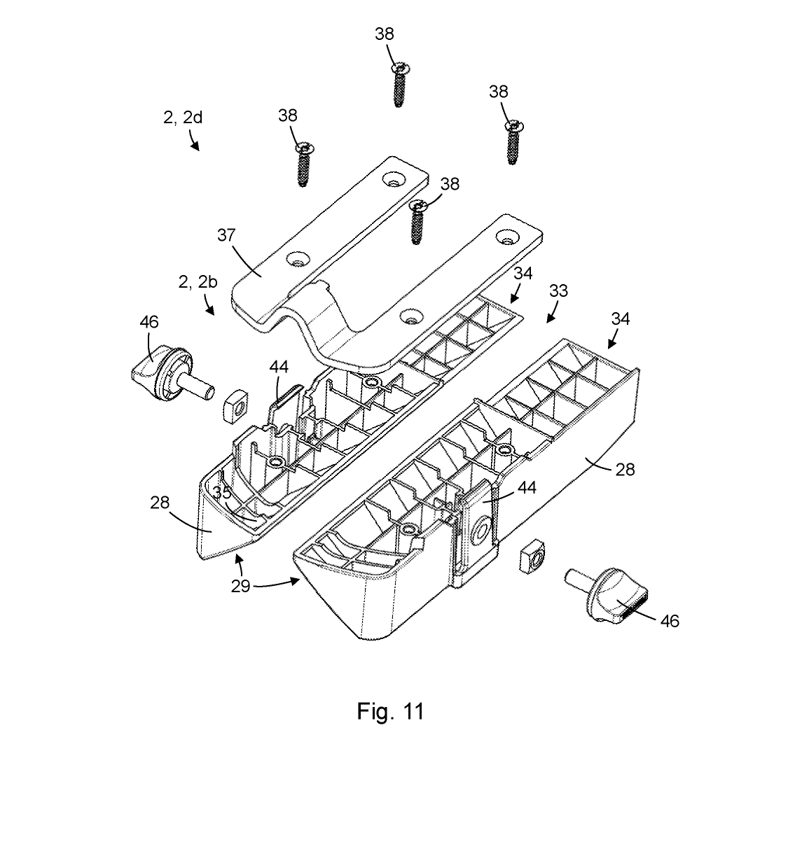

The stiffening element 37 is, for example, a die-cast aluminum part, in particular in the case of the chamfer sole 2a according to the first variant. Alternatively, the stiffening element 37, as shown for example in FIGS. 9 and 11, can be a stamped sheet metal part and/or a folded bracket.

The stiffening element 37 is arranged in particular on the upper side (i.e., the side facing the planer sole 6 in the chamfer planing configuration) of the chamfer sole body 28. Exemplarily, the stiffening element 37 is attached to the chamfer sole body 28 via fastening elements 38, in particular screws.

The stiffening element 37 exemplarily extends over at least 60% or at least 70% or at least 80% of the longitudinal extension of the chamfer sole 2 and/or of the chamfer sole body 28.

Exemplarily, the chamfer sole body 28 and/or the stiffening element 37 each have a U-shape. The chamfer sole body 28 in particular has body legs and a body connecting section which interconnects the body legs. The stiffening element 37 in particular has stiffening element legs and a stiffening element connecting section which interconnects the stiffening element legs. Exemplarily, each chamfer sole leg 34 is formed by a respective body leg and a stiffening element leg attached to this body leg. The connecting section 35 is exemplarily formed by the body connecting section and the stiffening element connecting section.

Exemplarily, the chamfer sole 2 has a front chamfer sole section 39 and a rear chamfer sole section 40 adjoining the front chamfer sole section 39 in the longitudinal direction (cf. FIG. 7). The rear chamfer sole section 40 is located exemplarily partially in the same longitudinal region in the chamfer planing configuration as the rear planer sole part 6b. The front chamfer sole section 39 is located in the chamfer planing configuration in the same longitudinal region as the support table 6a.

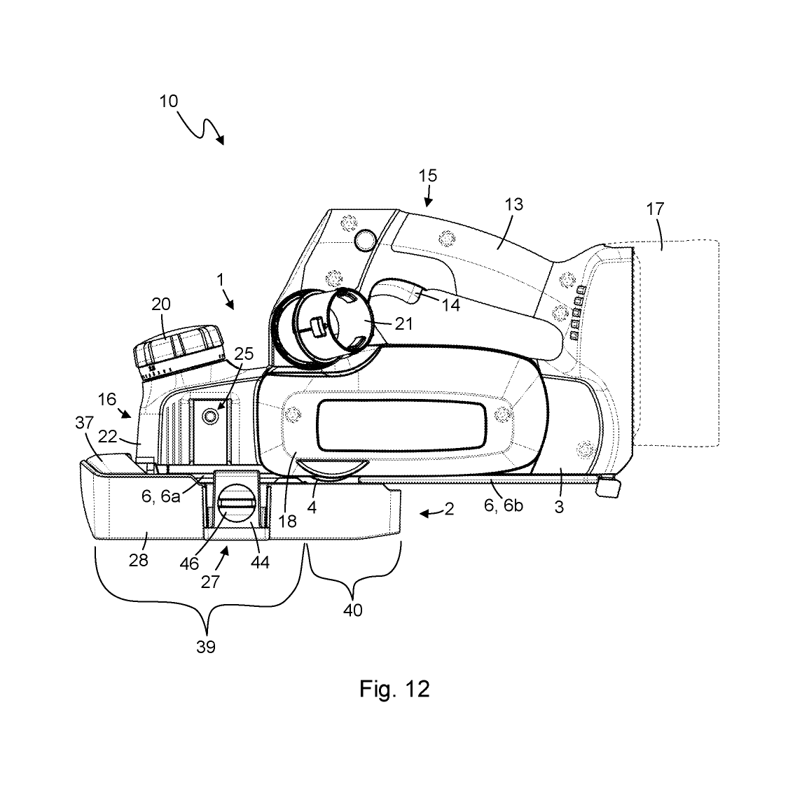

FIG. 12 shows the electric planer device 10 in a side view (in the chamfer planing configuration). Exemplarily, the rear chamfer sole section 40 is located in the same longitudinal region of the electric planer device 10 as the planer shaft 4 and a front section of the rear planer sole part 6b. Exemplarily, the longitudinal extension of the chamfer sole 2 is at least 30% or at least 40% or at least 50% of the longitudinal extension of the electric planer apparatus 1 (or of the planer sole 6). Exemplarily, the longitudinal extension of the chamfer sole 2 is a maximum of 80% or a maximum of 70% or a maximum of 50% of the longitudinal extension of the electric planer apparatus 1 (or of the planer sole 6). The chamfer sole 2 is expediently not attached to the rear planer sole part 6b and preferably does not touch the rear planer sole part 6b.

The chamfer sole legs 34 and/or the stiffening element 37 exemplarily extend (in the longitudinal direction) over the front chamfer sole section 39 and the rear chamfer sole section 40. Exemplarily, the front chamfer sole section 39 has a front top side 41, which in particular lies higher than a rear top side 42 of the rear chamfer sole section 40 (cf. FIG. 5).

The front top side 41 and the rear top side 42 each define a respective horizontally aligned top side plane. Between the front top side 41 and the rear top side 42, a step 43 is exemplarily present. Exemplarily, the front top side 41 and the rear top side 42 are each provided by the top sides of the stiffening element legs. The stiffening element legs exemplarily each have the step 43.

The chamfer sole clearance 33 extends over the front chamfer sole section 39 and the rear chamfer sole section 40. The chamfer sole clearance 33 is narrower in the front chamfer sole section 39 (in the width direction) than in the rear chamfer sole section 40, in particular for the reason that the chamfer sole clearance 33 lies higher in the front chamfer sole section 39 than in the rear chamfer sole section 40, and the two chamfer sole contact surfaces 29 run towards each other in the upward direction. Since the chamfer sole 2 is attached to the support table 6a in the chamfer planing configuration, the offset between the front top side 41 and the rear top side 42 makes it possible to adjust a chamfer width of the chamfer to be produced, meaning to position the support table 6a higher in the vertical direction than the rear planer sole part 6b.

The attachment interface 27 will be discussed in more detail below.

The chamfer sole 2 comprises the attachment interface 27, with which the chamfer sole 2 can be attached, in particular without tools, to the electric planer apparatus 1, in particular to the planer sole 6, preferably to the support table 6a, in order to set the electric planer device 10 into the chamfer planing configuration. Expediently, the chamfer sole 2 can be removed, in particular without tools (in particular via the attachment interface 27), from the electric planer apparatus 1, in particular the planer sole 6, preferably the support table 6a, in order to set the electric planer device 10 into the planar planing configuration.

Preferably, the attachment interface 27 has at least two, in particular flexurally elastic, fastening elements, as well as at least two fixing elements 46, in particular locking screws, by means of which the fastening elements can be tensed and/or adjusted. The fastening elements are in particular the engagement elements 44 explained below.

The attachment interface 27 has at least two engagement elements 44, in particular engagement tabs, which can be brought into engagement with the attachment structure 23, in particular the attachment sections 24 of the electric planer apparatus 1, to attach the chamfer sole 2 to the electric planer apparatus 1. Exemplarily, a respective engagement element 44 is arranged on each longitudinal side of the chamfer sole, in particular in the front chamfer sole section 39. Exemplarily, each engagement element 44 has at its upper end an inwardly protruding engagement projection 45, which can be brought into engagement with a respective attachment section 24.

Expediently, the attachment interface 27 has at least two fixing elements 46, in particular locking screws, by means of which the engagement elements 44 can be fixed in an engagement position in which the engagement elements 44 are in engagement with the attachment structure 23. Expediently, the attachment structure 23 is part of the support table 6a adjustable relative to the planer shaft 4 or is arranged thereon.

Expediently, the attachment interface 27 comprises a form-fit element 47, which is preferably arranged in the front chamfer sole section 39, in order to interact with a front section of the support table 6a in the chamfer planing configuration, in particular to enclose it. Thus, in the chamfer planing configuration, a twisting of the chamfer sole 2 relative to the electric planer apparatus 1 around an axis parallel to the planer shaft 4 can be effectively prevented.

Further advantageously, the attachment interface 27 comprises on the side of the front chamfer sole section 39 lying opposite the form-fit element 47 in the longitudinal direction a stop element 48 and/or a clip element, which is designed to abut against a rear side of the support table 6a in the chamfer planing configuration. Thus, the chamfer sole 2 is effectively secured against slipping of the chamfer sole 2 in the longitudinal direction in the chamfer planing configuration.

Exemplarily, each fixing element 46 extends through a respective opening through a respective engagement element 44 into the chamfer sole body 28 (and/or the stiffening element 37), in particular into a thread provided there. By manual actuation, in particular rotation, of the fixing elements 46, the engagement elements 44 are pressed inwards – i.e., towards the chamfer sole body 28. Expediently, clamping of the chamfer sole 2 to the electric planer apparatus 1, in particular to the support table 6a, takes place by means of the engagement elements 44. According to an alternative embodiment, the chamfer sole can be removably attached to the electric planer apparatus 1, in particular the support table 6a, by clipping, in particular by corresponding clip elements. According to a further alternative embodiment, the chamfer sole can be removably attached to the electric planer apparatus 1, in particular the support table 6a, by means of at least one toggle lever.

As mentioned above, the electric planer device 10 can be selectively set into the planar planing configuration or into the chamfer planing configuration.

In order to set the electric planer device 10 into the planar planing configuration, the fixing elements 46 can be loosened, exemplarily by manual rotation, and the chamfer sole 2 can then be completely removed from the electric planer apparatus 1, exemplarily by pulling the chamfer sole 2 off the electric planer apparatus 1 completely in a forward direction along the longitudinal axis.

In the planar planing configuration, the electric planer apparatus 1 can be placed flatly with the planer sole contact surface 7 of the planer sole 6 onto the planar workpiece surface 8 in order to perform a planar chip removal from the workpiece surface 8 with the planer shaft 4 during a feed of the electric planer device 10 relative to the planar workpiece surface 8. A planar chip removal from the workpiece surface 8 means, for example, that a path is planed into the workpiece surface 8 whose width expediently corresponds to the width of the planer shaft 4. The workpiece surface 8 is part of a workpiece 9 (cf. FIG. 1), which can also be referred to as the first workpiece. The first workpiece 9 is, for example, a plate, in particular a wooden plate. In the planar planing configuration, the planer sole contact surface 7 is exposed; the chamfer sole 2 is completely removed from the electric planer apparatus 1 and is not used during planing. The planer shaft rotation axis 11 is aligned parallel to that surface – the planer sole contact surface 7 – with which the electric planer apparatus 1 rests flatly on the workpiece surface 8 from which the chip removal occurs.

The electric planer device 10 can in particular be set into the chamfer planing configuration in that the chamfer sole 2 is pushed from the front along the longitudinal direction onto the support table 6a of the electric planer apparatus 1, and then the fixing elements 46 are actuated, in particular by manual rotation, in order to fix the chamfer sole 2 to the support table 6a. Expediently, in this state the chamfer sole 2 is fixed to the support table 6a in all spatial directions relative to it. The chamfer sole 2 covers the front planer sole contact surface 7a and expediently the rear planer sole contact surface 7b (at least partially).

Exemplarily, the chamfer sole 2 in the chamfer planing configuration does not protrude laterally beyond the outer housing 3, in particular the motor housing section 18, on at least one side, in particular a longitudinal side, of the electric planer apparatus 1.

Exemplarily, the chamfer sole 2 protrudes forward beyond the planer sole 6, in particular the support table 6a. Exemplarily, the connecting section 35 of the chamfer sole 2 is located in the chamfer planing configuration in front of the front side (in the feed direction) of the electric planer apparatus 1 and in particular abuts against the front side. The front side belongs in particular to the apparatus front section 16.

Expediently, the chamfer sole 2 encloses the support table 6a in the chamfer planing configuration on at least three sides, namely exemplarily on the two longitudinal sides and the front side of the support table 6a.

Preferably, the chamfer sole 2 in the chamfer planing configuration is exclusively attached to the support table 6a. Through a height adjustment of the support table 6a (for example by means of the adjustment operating element 20 or the adjustment mechanism 19), the height of the chamfer sole 2 relative to the planer shaft 4 can be set. In this way, the chamfer width of the chamfer that is planed into the workpiece edge 30 can be set.

In the chamfer planing configuration, the electric planer device 10 can be placed flatly with the two chamfer sole contact surfaces 29 of the chamfer sole 2 simultaneously onto the two workpiece surfaces 31 converging to the workpiece edge 30 in order to chamfer the workpiece edge 30 with the planer shaft 4 during a feed of the electric planer device 10 relative to the workpiece edge 30. In particular, a first chamfer sole contact surface 29 rests on a first workpiece surface 31 and, simultaneously, a second chamfer sole contact surface 29 rests on the second workpiece surface 31. Expediently, the workpiece 32 is not touched by the planer sole 6 during the chamfering of the workpiece edge 30. In the chamfer planing configuration, the planer shaft rotation axis 11 intersects the contact planes defined by the chamfer sole contact surfaces 29, in particular at an angle of 45 degrees.

Through the simultaneous contact of the chamfer sole contact surfaces 29 on the workpiece surfaces 31, a relative vertical positioning between the workpiece edge 30 and the chamfer sole 2 is unambiguously defined.

In the following, further features that can be realized in the chamfer sole 2 will be discussed with reference to FIGS. 9 to 11. In particular, individual features of the variants discussed below can be combined with one another and/or can be realized or not realized in the previously explained chamfer sole 2, in particular in the first variant 2a. Except for the features discussed below, the variants discussed in the following are preferably configured like the previously discussed chamfer sole 2, so that the explanations relating to the previously discussed chamfer sole 2 apply to that extent to the variants explained below as well.

FIG. 9 shows a chamfer sole 2b according to a second variant. Exemplarily, the stiffening element 37, in particular the stiffening element legs, does not extend over the rear chamfer sole section 40; thus ends at the end of the front chamfer sole section 39. The connecting section 35 is exemplarily arc-shaped.

FIG. 10 shows a chamfer sole 2c according to a third variant. Exemplarily, no stiffening element 37 is present. The stiffness of the chamfer sole 2c is expediently ensured exclusively by the chamfer sole body 28. The connecting section 35 exemplarily extends over the front chamfer sole section 39. Thus, the chamfer sole clearance 33 does not extend over the front chamfer sole section 39, but only over the rear chamfer sole section 40.

FIG. 11 shows a chamfer sole 2d according to a fourth variant. Exemplarily, the chamfer sole body 28 has no body connecting section. Accordingly, the chamfer sole body 28 is divided into two separate parts, namely the two body legs. The two body legs are interconnected in particular exclusively via the stiffening element 37.

1. An electric planer device, comprising:
a chamfer sole as well as an electric planer apparatus, which has a planer shaft,
an electric drive unit for driving the planer shaft, and
a planer sole,
wherein the electric planer device can be selectively set into a planar planing configuration or into a chamfer planing configuration, wherein the electric planer device in the planar planing configuration can be placed flatly with a planer sole contact surface of the planer sole onto a planar workpiece surface in order to perform, during a feed of the electric planer device relative to the planar workpiece surface, a planar chip removal from the workpiece surface with the planer shaft, and wherein the electric planer device in the chamfer planing configuration can be placed flatly with two chamfer sole contact surfaces of the chamfer sole simultaneously onto two workpiece surfaces converging to a workpiece edge in order to chamfer, during a feed of the electric planer device relative to the workpiece edge, the workpiece edge with the planer shaft.

2. The electric planer device according to claim 1, wherein the chamfer sole is configured as a single part.

3. The electric planer device according to claim 1, wherein the chamfer sole has an attachment interface with which the chamfer sole can be attached to the electric planer apparatus in order to set the electric planer device into the chamfer planing configuration and/or the chamfer sole can be removed from the electric planer apparatus in order to set the electric planer device into the planar planing configuration.

4. The electric planer device according to claim 3, wherein the chamfer sole can be attached to the planer sole in order to set the electric planer device into the chamfer planing configuration and/or the chamfer sole can be removed from the planer sole in order to set the electric planer device into the planar planing configuration.

5. The electric planer device according to claim 4, wherein the planer sole comprises a support table which is adjustable relative to the planer shaft in order to set a depth of the planar chip removal in the planar planing configuration and/or to set a chamfer width of the chamfer to be produced in the chamfer planing configuration, and wherein the chamfer sole can be attached to the support table in order to set the electric planer device into the chamfer planing configuration and/or the chamfer sole can be removed from the support table in order to set the electric planer device into the planar planing configuration.

6. The electric planer device according to claim 3, wherein the attachment interface has at least two engagement elements which can be brought into engagement with an attachment structure of the electric planer apparatus for attaching the chamfer sole to the electric planer apparatus, and has at least two fixing elements by means of which the engagement elements can be fixed in an engagement position in which the engagement elements are in engagement with the attachment structure.

7. The electric planer device according to claim 1, wherein the chamfer sole has a chamfer sole clearance arranged between the chamfer sole contact surfaces, through which the workpiece edge can be guided to the planer shaft in the chamfer planing configuration in order to chamfer the workpiece edge.

8. The electric planer device according to claim 1, wherein the chamfer sole has two chamfer sole legs, which each provide a respective chamfer sole contact surface, wherein the chamfer sole legs are interconnected via a connecting section located in a front region of the chamfer sole.

9. The electric planer device according to claim 8, wherein the connecting section has a cutout along an imaginary intersecting line at which contact planes defined by the chamfer sole contact surfaces intersect, so that when the chamfer sole contact surfaces are placed flatly on the converging workpiece surfaces, the chamfer sole does not rest on the workpiece edge.

10. The electric planer device according to claim 1, wherein the chamfer sole has a chamfer sole body, which provides the two chamfer sole contact surfaces and is manufactured from a first material, and further has at least one stiffening element attached to the chamfer sole body, which is manufactured from a second material.

11. A chamfer sole with an attachment interface for removable attachment to an electric planer apparatus, in order to form with the electric planer apparatus an electric planer device usable as a chamfer planer,
wherein the chamfer sole comprises a chamfer sole body with two chamfer sole contact surfaces, which define two intersecting contact planes and serve for the simultaneous flat contact of the chamfer sole on two workpiece surfaces converging to a workpiece edge, as well as a chamfer sole clearance arranged between the two chamfer sole contact surfaces, through which the workpiece edge can be guided to a planer shaft of the electric planer apparatus in order to chamfer the workpiece edge with the planer shaft.

12. The chamfer sole according to claim 11, wherein the chamfer sole has two chamfer sole legs, which each provide a respective chamfer sole contact surface, wherein the chamfer sole legs are interconnected via a connecting section located in a front region of the chamfer sole.

13. The chamfer sole according to claim 11, wherein the attachment interface has at least two fastening elements, as well as at least two fixing elements, by means of which the fastening elements can be tensed and/or adjusted.

14. The chamfer sole according to claim 11, wherein the chamfer sole has a chamfer sole body, which provides the two chamfer sole contact surfaces and is manufactured from a first material, and further has at least one stiffening element attached to the chamfer sole body, which is manufactured from a second material.

15. A method for operating an electric planer device according to claim 1, comprising the steps:
in the planar planing configuration, flatly placing the planer sole contact surface onto the planar workpiece surface and feeding the electric planer device relative to the planar workpiece surface to perform the planar chip removal with the planer shaft;
setting the electric planer device into the chamfer planing configuration;
in the chamfer planing configuration, flatly placing the chamfer sole contact surfaces simultaneously onto the workpiece surfaces converging to the workpiece edge and feeding the electric planer device relative to the workpiece edge to chamfer the workpiece edge.

16. The electric planer device according to claim 1, wherein the electric planer apparatus is a hand-guided electric planer apparatus.

17. The electric planer device according to claim 3, wherein the chamfer sole can be attached without tools to the electric planer apparatus in order to set the electric planer device into the chamfer planing configuration and/or the chamfer sole can be removed without tools from the electric planer apparatus in order to set the electric planer device into the planar planing configuration.

18. The electric planer device according to claim 6, wherein the engagement elements are engagement tabs, and/or the fixing elements are locking screws, and/or wherein the attachment structure is part of a support table adjustable relative to the planer shaft or is arranged on the support table and/or wherein in the chamfer planing configuration the chamfer sole is not screwed to the electric planer apparatus.

19. The electric planer device according to claim 10, wherein the first material is plastic and the second material is metal.

20. The chamfer sole according to claim 11, wherein the chamfer sole legs are interconnected exclusively via the connecting section.
